(19) United States
(12) Patent Application Publication
(10) Pub. No.: US 2013/0093898 A1
(43) Pub. Date: Apr. 18, 2013

(54) Video Surveillance System and Method via the Internet

(71) Applicants: Edsel James Tink, North Gower (CA); Victor Gottardi, Ottawa (CA)

(72) Inventors: Edsel James Tink, North Gower (CA); Victor Gottardi, Ottawa (CA)

(73) Assignee: Honeywell International Inc., Morristown, NJ (US)

(21) Appl. No.: 13/273,131

(22) Filed: Oct. 13, 2011

(51) Int. Cl. H04N 7/18

(52) U.S. Cl. 348/159; 348/E07.085

(57) ABSTRACT

A video surveillance system includes at least one of a camera or a streamer. A database server is coupled to the camera or streamer via a recording server and a publicly available computer network. Metadata for a video clip from the camera or streamer can be stored, along with incoming video at a media storage servers. A user can make a request, via a publicly available computer network for selected video or audio.

### FIELD

The application pertains to scalable video surveillance systems which can support large numbers of video cameras. More particularly, the application pertains to such systems which offer Cloud based video surveillance services.

### BACKGROUND

Surveillance systems with direct database server storage can be configured for use with large numbers of video cameras. One such embodiment is disclosed in U.S. patent application Ser. No. 13/086,930 filed Apr. 14, 2011, entitled “Surveillance System With Direct Database Server Storage”. The '930 application is assigned to the assignee hereof and is incorporated herein by reference.

The '930 application describes a novel way to overcome the limited scalability of Network Video Recorders (NVRs). This solution deploys database server technology for the centralized management and search functions of video and audio recordings and redistributes the recording and retrieval functionality to the IP Cameras and client applications respectively. However, practical deployments may be limited to installations, or entities having secure private networks with high network bandwidth capacity such as those used by casinos and airports. Furthermore, software modifications may be required to the video sources (IP cameras and streamers) restricting the customer's choice of manufacturer.

It would be desirable to be able to take advantage of publicly available Internet access and communications capabilities to provide scalable video surveillance systems, which can cost effectively support large numbers of surveillance cameras, in commercial and residential installations.

### BRIEF DESCRIPTION OF THE DRAWING

FIG. 1 is a diagram of a system in accordance herewith.

### DETAILED DESCRIPTION

While disclosed embodiments can take many different forms, specific embodiments hereof are shown in the drawings and will be described herein in detail with the understanding that the present disclosure is to be considered as an exemplification of the principles hereof, as well as the best mode of practicing same, and is not intended to limit the claims hereof to the specific embodiment illustrated.

In one aspect, video recording servers incorporated into a surveillance system without network video recorders can receive video and audio from pluralities of cameras via a publicly available computer network, such as the Internet. The received video and audio can be stored, and managed, via database servers, on media storage servers without any need for networked video recorders.

Users, via requesting computers such as laptops, or desktops, or with personal communications devices can, via the public computer network, request downloads of selected video and/or audio clips. Local retrieval servers retrieve requested video and/or audio which can be downloaded from the media storage servers, via the Internet to the user's requesting device.

Recording transactions over the Internet via the local recording server(s) provides secure access to the media storage servers. Large numbers of camera inputs, or streamers, can be supported.

Protocol conversation can be provided facilitating the use of any manufacturer's video source device(s) without requiring special hardware, or, software at the input devices. Providing HTTP-type communications facilitates traversing Internet paths through gateways, and firewalls without any need for opening or configuring non-standard ports.

Retrieval proxy services provide secure end-user service to access, search and streaming of recorded, or delayed live, video over the Internet to Internet enable devices which can support video.

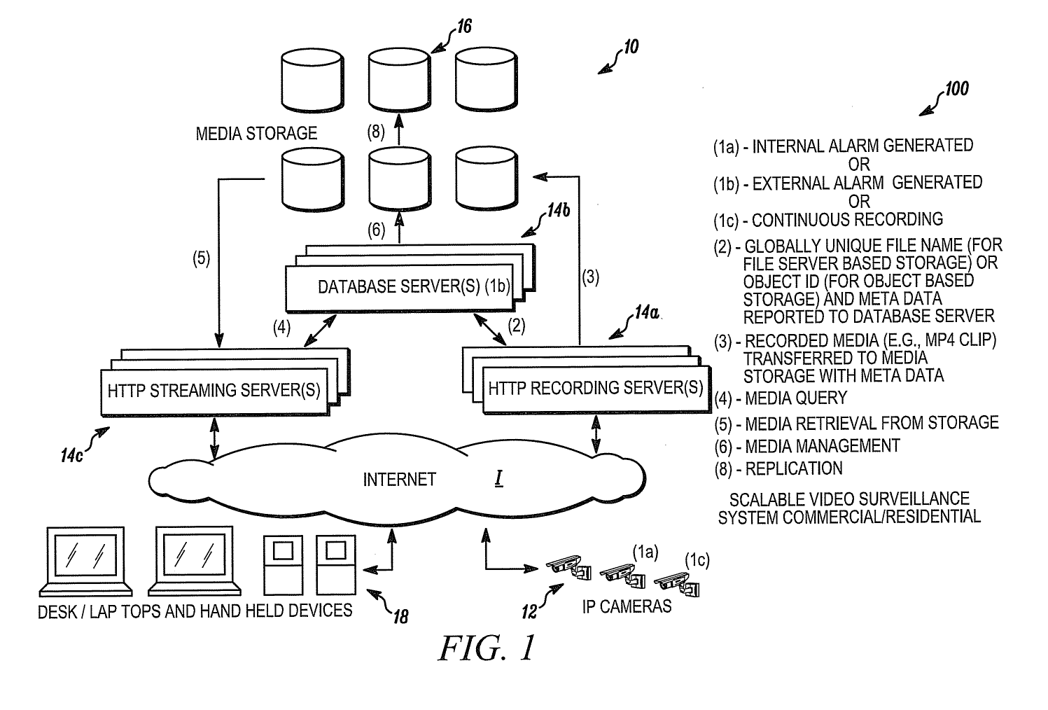

FIG. 1 illustrates a system 10 of the type described above. In system 10, pluralities of IP cameras and/or streamers 12 are coupled via Internet I, to one or more recording servers, indicated at 14a. The servers 14a are coupled to database servers 14b, and, to media storage servers 16. As illustrated in FIG. 1 outputs from cameras or streamers in pluralities 12 are coupled to media storage 16 without any networked video recorders being interposed between sources 12 and storage units 16.

Streaming output server(s) 14c are coupled to the storage units 16. They are also coupled via the Internet Ito user workstations 18. The workstations 18, in this embodiment, communicate via servers 14c to the media storage servers 16.

Coupling the server(s) 14a, 14c between inputs 12, storage servers 16 and workstations 18 provides efficient centralized management and search functions of the video and audio recordings. The video and audio data, from sources 12 is recorded on storage servers 16 and the associated metadata communicated to server(s) 14b. Client applications running on one or more of the workstations 18 can query the metadata, via the server(s) 14c for stored audio or view recordings. Those recordings can be retrieved directly from storage servers 16 for review and monitoring at the requesting workstation 18.

FIG. 1 also illustrates additional aspects of a method 100 of operation of the system 10. As illustrated in FIG. 1, globally unique file names, or object ID and metadata can be reported to database server(s) 14b, as indicated at 2. Recorded media, received via the Internet I from cameras or streamers 12 can be transferred to media storage 16, as illustrated at 3, along with associated metadata.

A media query can be received at servers 14b, from the units 18, via Internet I, as illustrated at 4. Retrieved media can be returned, via servers 14c to workstations 18, via internet I, as illustrated at 5.

Media management can be provided by servers 1b, as illustrated at 6. If desired, received video, and/or audio along with metadata can be replicated for backup as illustrated at 8.

In summary, in system 10, the database server(s) 14b provide opportunities for more intelligent storage management than is the case with individual cameras by including system wide parameters and metadata in the decision criteria. For example, alarm generated clips can be kept longer than continuous recordings or those for which the metadata match a specific criteria can be kept longer than a default retention time interval.

Storing the metadata with the recordings in media storage servers 16 enables the database server(s) 14b to test the integrity of media storage (detect missing or lost recordings) and also facilitates rebuilding the database using the metadata from media storage if needed. Additionally, time delayed video and audio (measured in a few to 10s of seconds) can be streamed directly from media storage 16, via servers 14c, and the Internet Ito client workstations 18.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. A surveillance system comprising:
a plurality of cameras;
one or more media storage servers which receive and store at least video signals from the cameras;
recording servers coupled to the cameras by a publicly available computer network; and
database servers coupled to the storage servers where the stored video signals can be searched in response to a user's query.

2. A system as in claim 1 which includes a plurality of user input units, coupled to the storage devices wherein a search command can be manually entered and executed by the control system.

3. A system as in claim 2 which includes circuitry to select and initiate operation of a camera.

4. A system as in claim 3 wherein selected information relative to video and audio data from an operating camera is stored in at least one of the storage servers.

5. A system as in claim 4 where the selected information comprises metadata.

6. A system as in claim 2 wherein a query from a user input unit can retrieve selected, stored video from the storage servers.

7. A system as in claim 1 where the storage servers store audio signals in addition to the video signals and the database servers implement centralized management and search functions of video and audio stored in the storage servers.

8. A video surveillance system comprising:
at least one of a camera or a streamer;
a database server to store metadata for a video clip from the camera or streamer in media storage servers; and
a recording server coupled to the camera or the streamer by a publicly available computer network, and, to the database server, wherein the recording server receives the clip from the camera in the absence of any intervening recording device.

9. A system as in claim 8 which includes circuitry to generate a trigger which activates at least the camera to obtain the video clip therefrom, and wherein metadata for the clip is stored by the database server.

10. A system as in claim 9 which includes a user station coupled to the servers by a publicly available computer network, and, wherein a query can be entered at the user station and, responsive thereto, the clip can be retrieved from one of the media storage servers.

11. A system as in claim 10 where the database server receives and stores audio clips wherein in response to a query from the user station, a selected audio clip can be retrieved from the media storage servers.

12. A system as in claim 11 where the database server implements centralized management and search functions of video and audio clips stored in the media storage servers.

13. A method of acquiring at least one video clip comprising:
providing a plurality of surveillance cameras;
at least intermittently obtaining video indicative of a region being monitored from one of the cameras via a publicly available computer network;
obtaining metadata associated with the video;
storing the metadata and at least the obtained video at a media storage servers;
responding to a query from a user by retrieving requested, stored, video from the media storage servers; and
visually presenting the retrieved video.

14. A method as in claim 13 which includes coupling requested video to a user via a publicly available computer network.

15. A method as in claim 13 which includes obtaining audio and storing the obtained audio at the media storage servers, and implementing centralized management and search functions of stored video and audio clips.

16. A method as in claim 15 which includes, receiving a query from a user for selected video, or audio from the media storage servers, via a publicly available computer network.

17. A method as in claim 16 which includes, coupling requested video to the user via the computer network.

18. A method as in claim 17 wherein the query from the user is coupled to the database servers via query related servers.

19. A method as in claim 18 which includes downloading requested video to the user, via the query related servers.
